(19) United States
(12) Patent Application Publication
(10) Pub. No.: US 2021/0215845 A1
(43) Pub. Date: Jul. 15, 2021

(54) Foreign Object Detector, Wireless Power Transmission System Comprising a Foreign Object Detector and Method of Detecting a Foreign Object

(71) Applicant: TDK Corporation, Tokyo (JP)

(72) Inventors: Abiezer Tejeda, Solothurn (CH); Hugh Hemphill, Solothurn (CH)

(21) Appl. No.: 17/055,063

(22) PCT Filed: May 18, 2018
(86) PCT No.: PCT/EP2018/063120

§ 371 Date: Nov. 12, 2020

(51) Int. Cl. G01V 3/10; H02J 50/60; H02J 50/10

(52) U.S. Cl. CPC G01V 3/10; H02J 50/10; H02J 50/60

(57) ABSTRACT

A foreign object detector, a wireless power transmission system and a method for detecting a foreign object are disclosed. In an embodiment a foreign object detector includes a plurality of sensing coils, each coil made of a plurality of straight strokes and an evaluation circuit connected to the sensing coils, wherein the detector is configured to detect a metallic or magnetic object foreign to a top surface of a wireless power transmission device having a transmission coil.

This patent application is a national phase filing under section 371 of PCT/EP2018/063120, filed May 18, 2018, which is incorporated herein by reference in its entirety.

### TECHNICAL FIELD

The present invention relates in general to the detection of metallic and/or other magnetic objects in the vicinity of a Wireless Power Transfer (WPT) system, in particular in the vicinity of a wireless power transmit coil. An inductive sensing coil is designed for increased sensitivity to metallic or other magnetic objects when operating within the field of a power transmitting device.

### BACKGROUND

Via wireless power transmission, electric power can be transferred from a transmission coil system to a reception coil system. The transmission coil system and the reception coil system can have a certain distance and no galvanic connection between the transmission coil system and the reception coil system is necessary. To that end, varying magnetic fields are applied. The frequency of varying magnetic fields can be in the range of 80 kHz.

However, a wireless power transfer system can transfer electric power in the range of several kilowatt. It is possible that metal objects close to such a system are heated or destroyed. To prevent unwanted effects caused by wireless power transfer systems foreign object detectors are employed. The foreign object detectors detect the presence of objects or of matter that could potentially cause unwanted effects. It is possible to use output signals of such foreign object detectors to deactivate wireless power transmission coils in such systems.

Current solutions to problems caused by unwanted effects can be ineffective because magnetic fields generated by inductive wireless transmitters couple easily into sensing circuits causing significant interference and loss of detection ability. Furthermore, it is possible that high frequency signals (e.g. in the range of 500 kHz) are injected into sensor electronic circuits causing the detection system to operate in a manner similar to capacitive sensors. The result is the detection of non-metallic objects, such as wet leaves, when metallic objects should be detected and a false detection will interrupt the transfer process.

Other solutions have the drawback of a null point, i.e. a location in the vicinity of the detector where the sensitivity of the detector is strongly reduced. This means that foreign objects located at this position cannot be detected.

Detection systems are known from U.S. Pat. No. 9,726,518 B2, describing the use of low coupling resonance sensors and solenoid or loop coils.

A wireless power transfer system is based on the principle of induction and/or resonance to enable the transfer of energy from a power transmitting device to a power receiving device without any mechanical or physical contact between the power transmitting device and the power receiving device. A time-varying magnetic field is generated by a time-varying current in the power transmitting device. In consequence, the power receiver device located near the power transmitting device picks up the changing magnetic field and converts it into electrical energy suitable to power, or charge, Battery Electric Vehicles.

In high power applications, such as charging of electric and hybrid electric vehicles, strong magnetic fields are generated. Any metal object falling in the area of this strong magnetic field will have induced eddy currents that can generate excessive heat and be potentially harmful to humans or the wireless power transmitting system itself (for example protective plastic assemblies). Detection of metallic objects is therefore required as a safety guard in high power wireless transfer systems. Metal detection systems have been reported in Patent Application Nos. US 2016238731 A1, US 2016238731 A1, US 2016238731 A1, US 2016006260 A1 or DE 102016219484 A1. Generally, one or more inductive sense coils are employed to detect metallic objects. Sense coil geometries are normally wound with one or more turns in a circular, square, rectangular, triangular, hexagonal, or, in general, convex polygonal geometries. Other coils combine two or more basic shapes to form a more complex winding pattern. These techniques are generally used to increase the detection sensitivity. In addition to the sense coil, commonly metallic object detection systems employ an electronic circuit to process changes in one or more electrical parameters of the sensing coil due to the presence of a metallic or magnetic object. Generally, the sensing coils are excited with a high frequency signal which generates a weaker magnetic field than that of the power transmitting system to monitor changes in frequency, phase, or quality factor. One drawback of such active detection methods is that they are prone to interference when the primary power transmitting coil is transferring power.

### SUMMARY

Embodiments provide a foreign object detector that works with a high reliability in particular in the presence of strong magnetic fields without interference between a transmission coil and the object detector systems.

Further embodiments provide a foreign object detector that can be used with a large number of different wireless power transmission systems. Thus, it would be appreciated if efforts for adapting a foreign object detector to another wireless power transmission system can be kept small.

To that end, a foreign object detector, a wireless power transmission system comprising a foreign object detector and a method of detecting a foreign object in the vicinity of the wireless power transmission system according to the independent claims are provided. Dependent claims provide preferred embodiments.

The foreign object detector comprises a plurality of sensing coils and an evaluation circuit connected to the sensing coils. The detector is provided to detect a metallic or magnetic object foreign to the top surface of a wireless power transmission device having a transmission coil. Of the plurality of sensing coils, each coil is made of a plurality of straight strokes.

Further, it is possible that the detector comprises a polygon shaped sensing coil and an evaluation circuit. The evaluation circuit can be connected to the sensing coil. It is possible but not necessarily needed that the voltage induced in the sensing coil has a dependence, e.g. a linear dependence, on a current in the transmission coil.

The foreign object detector and the wireless power transmission system can be different systems. However, it is possible that the foreign object detector is a part of the wireless power transmission system and that the wireless power transmission system is a part of the foreign object detector.

It is possible that the wireless power transmission system also has a reception coil or a plurality of reception coils and one or more additional transmission coils.

The sensing coil has conductor segments arranged essentially expanding within a plane. The conductor segments are arranged such that a polygon shape of the sensing coil is obtained. Thus, the polygon shape of the sensing coil especially refers to the conductor segments of the sensing coil. The sensing coil can comprise conductor segments in one or a plurality of windings. The term “winding” does not necessarily denote curved conductor segments. It is preferred that the conductor segments comprise straight, uncurved segments.

It was found that polygon shaped sensing coils can be used to establish foreign object detectors for wireless power transmission systems because a voltage in the sensing coil inducted by the transmission coil can be distinguished from a voltage in the sensing coil induced by a foreign object to be detected. Further, polygrams have been found to be more sensitive due to having more edges and internal loops than other sense coil geometries.

Thus, monitoring the voltage inducted in the sensing coil and monitoring a current flowing in the transmission coil provides the possibility of determining the presence of a foreign object even when the transmission coil operates with strong magnetic fields.

The linear dependence between the induced voltage and the current in the transmission coil makes it easy to detect a deviation of the induced voltage caused by a foreign object. A dependence, e.g. a linear dependence, between the induced voltage and the current can be stated as:

V=K*I.

Here, V is the induced voltage, I is the current in the transmission coil and K is the proportionality factor. K can depend on the operation frequency of the wireless power transmission system: K=ω*M. ω is the angular frequency and M is the mutual inductance between the transmission coil and the sensing coil.

Thus, knowing one value for a given operation frequency co provides the possibility of easily monitoring the environment of the transmission system. If a voltage is induced that deviates from the predicted voltage according to the above-mentioned equation, then—considering a certain uncertainty level caused by tolerances—the presence of a foreign object, e.g. a piece of metal, can be determined with a high reliability even at high power levels. a metal object detector system is presented that can be used in conjunction with a wireless power transfer system comprising a power transmitting device and a power receiving device. The metal object detector comprising a multitude of sensing coils distributed on the top surface area of the power transmitting device. The sensing coils having a specific geometry for improved sensitivity to foreign objects in the presence of high magnetic fields.

A sensing coil provides geometries better suited for improved sensitivity of metal object detection in a wireless power transfer system or other applications where strong magnetic fields are generated by a first transmitting coil. The apparatus and method of detection rely on Faraday's law of induction. A voltage is induced in the sense coil by a changing electromagnetic field generated by a changing current applied in the power transmitting device. When a metallic or any magnetic object falls on the sensing area of a sense coil, there is a change in the induced voltage of the sensing coil due to changes in the mutual inductance between the power transmitting device and the sensing coil. This change in induced voltage is used by an electronic processing unit to determine the presence or absence of metallic or magnetic objects.

It is possible that the sensing coil is preferably made of conducting wire with five straight strokes forming a pentagram. The sensing coil having one or more turns. The sense coil can have an outer winding having one or more turns connecting each of the five points of the pentagram.

It is further possible that the sense coil is preferably made of conducting wire with six straight strokes forming a hexagram shape. The sense coil can have an outer winding having one or more turns connecting each of the six points of the hexagram.

It is further possible that the sense coil is preferably made of conducting wire with seven straight strokes forming a heptagram shape. The sense coil can have an outer winding having one or more turns connecting each of the seven points of the heptagram.

It is possible that the sense coil is preferably made of conducting wire with eight straight strokes forming a octagram shape. The sense coil can have an outer winding having one or more turns connecting each of the eight points of the octagram.

More generally, the sensing coils can be defined as polygrams {n/2} or {n/3} where n={5, 6, 7, 8}.

In the present context the wording “pentagram” and “hexagram” are also used to refer to the 5-pointed and 6-pointed stars, respectively.

The polygram coils can be terminated by an outer perimeter coil of one or more turns joining the star points.

It is possible that the foreign object detector further comprises one or more additional polygon shaped sensing coils.

Further, it is possible that the foreign object detector further comprises one or more additional evaluation circuits for determining the presence or absence thereof of a metallic or magnetic material.

Two or more sensing coils can be electrically connected in a series configuration or in a parallel configuration. In a series configuration two or more sensing coils are electrically connected in series. In a parallel configuration two or more sensing coils are electrically connected in parallel. It is also possible that a parallel connection of sensing coils can be electrically connected in series and that series configurations are electrically connected in parallel. However, it is possible to use sensing coils individually.

Thus, by utilizing a polarization of polygon shaped sensing coils a large detection area can be covered. It is possible that foreign objects can be detected if the size of the objects is not smaller than half of the distance between two adjacent sensing coils.

This increases the sensitivity and reduces detrimental interactions of magnetic field originating from the transmission coil and entering the sensing coil.

The sensing coil can be a polarized coil.

Using a polarized coil renders orientating the field direction of the sensing coil with respect to the direction of the magnetic fields simple.

The sensing coil can have a coil core. The core of the sensing coil can be selected from an air core, a ferromagnetic core and a core with a relative permeability of 10,000 or smaller.

An air core consists of air located between the conductor segments of the sensing coil. The presence of a ferromagnetic core means the presence of a ferromagnetic material between or in the vicinity of the conductor segments of the sensing coil.

It is possible to use material of the magnetic core of the transmission coil as material of the sensing coil core.

It is possible that the sensing coil has a winding comprising a conductor selected from an enamelled wire, a Litz wire, an insulated wire, conduction segments structured on a wiring board or similarly created conductors.

It is possible that the sensing coil is electrically connected with the capacitance element to establish a resonance circuit.

The sensing coil can be electrically connected in parallel or in series to the capacitance element. The corresponding resonance circuit has a characteristic resonance frequency that depends from the coil's inductance, from the capacitance element's capacity and from the resonance circuit's environment. Thus, if the environment of the resonance circuit changes, e.g. because of an appearing foreign object, then the resonance frequency is varied and the variation of the resonance frequency can be detected.

Correspondingly, a change of the resonance frequency indicates the appearance of a foreign object.

It is possible that a conducting material of the sensing coil is selected from copper, an alloy comprising copper, silver, an alloy comprising silver and other metals and alloys that are typically used for coils in the field of wireless power transmission systems.

It is possible that one or more of the plurality of sensing coils are formed by at least 5 straight, crossing segments forming a pentagram shape.

It is possible that the pentagram shaped sensing coil is enclosed by an outer coil that connects the pentagram coil points.

It is possible that one or more of the plurality of sensing coils are formed by at least 6 straight crossing segments forming a hexagram shape.

It is possible that the hexagram shaped sensing coil is enclosed by an outer coil that connects the hexagram coil points.

It is possible that the hexagram shaped sensing coil is be made by two series-connected equilateral triangular coils arranged to form the hexagram shape.

It is possible that the hexagram-shaped sensing coil can be made by two parallel-connected equilateral triangular coils arranged to form a hexagram.

It is possible that one or more of the plurality of sensing coils are formed by at least 7 straight, crossing segments forming a heptagram shape.

It is possible that the heptagram-shaped sensing coil is enclosed by an outer coil that connects the heptagram points.

It is possible that one or more of the plurality of sensing coils are formed by at least 8 straight, crossing segments forming an octagram.

It is possible that the octagram-shaped sensing coil is enclosed by an outer coil connecting the octagram points.

It is possible that the octagram-shaped sensing coil is enclosed by an outer coil that connects the octagram points.

It is possible that the polygram sensing coils are be formed by connecting in series or parallel regular polygons that are arranged so that the final shape is a polygram of n=5, 6, 7 or 8.

A wireless power transmission system can comprise a transmission coil and a foreign object detector as described above.

Then, it is possible that the evaluation circuit is used to monitor the induced voltage and to monitor the current in the transmission coil. If a corresponding deviation, e.g. from a predicted dependence, is monitored then then the evaluation circuit can determine the presence of a metallic or magnetic object.

A method of detecting a foreign object in the vicinity of the wireless power transmission system, in particular in the vicinity of a wireless power transmission coil, comprises the steps:
monitoring an induced voltage in the sensing coils,
determining a safety interval for an induced signal of a sensing coil,
monitoring the induced voltage in the sensing coils, and
triggering an activation signal if the induced voltage is outside the safety interval.

It is possible that the safety interval is determined according to a linear dependence between the current and a voltage induced in the sensing coil or according to a change in a quality factor or a resonance frequency of a resonance circuit.

It is possible that the method can be used to detect metal or a metal-containing object in the vicinity of the detector.

Thus, a new design foreign object detector, e.g. in wireless power transmission systems, is provided. The new design is realized in embodiments that improve the detection sensitivity even under high magnetic field intensity without interference between the transmission coil and one or several coils of the detector.

The sensing coils can have three-sided polygons (triangles) or more than three sides. Thus, the sensing coils can also comprise or consist of rectangles, pentagons, etc.

It is possible to combine several polygon shaped coils to a common foreign object detector sensing coil.

The suggested method eliminates or strongly reduces the need for pre-stored information. Mainly one proportionality factor per sensing coil is needed to provide a stable and reliable functioning of the detector.

The operating frequency of the wireless power transmission coil or of the foreign object detector can be lower than 150 kHz. In this frequency range there is no significant effect of parasitic capacitance found in the detector circuitry. Thus, higher frequency components do not occur and do not disturb the detector's functioning.

Detecting a foreign object can be achieved by measuring changes in the induced voltage of the sensing coil. A reference or expected induced voltage can be determined based on the transmission coil current amplitude. The mutual inductance between the transmission coil and the sensing coil changes when a metallic object is on or around the detector. By utilizing polygon shaped sensing coils tolerances are significantly reduced and null points with a strongly reduced sensitivity are prevented.

The polygon shape can be a simple polygon without side edges or star polygons with crossing edges or the sensing coil can be a combination of a star polygon and a simple polygon. In particular, it is preferred that the sensing coil shape contains as many edges as possible. The edges are defined by the positions of the conductor segments. A star polygon, a combined star and symbol polygon and a simple polygon shape offer a large number of edges in a small area.

Lower induced voltage levels in the sensing coil can be achieved when the coupling factor between the transmission coil and the sensing coil is sufficiently small. A low coupling factor can be obtained when the field directions are perpendicular. The sensing coils can be designed such that the coupling between each coil and the power transmitting device is relatively small so that the interference between induced voltage and control is reduced or eliminated. Also, each sensing coil can have difference number of turns depending on the coupling factor between the sensing coil and the power transmitting device.

The sensing coil or a plurality of sensing coils can be placed on a horizontal plane parallel to the plane in which the transmission coil windings are arranged.

The sensing coil or a plurality of sensing coils can be placed inside or near, e.g. horizontally and vertically shifted, the power transmission coil, on top of the power transmission coil or outside the power transmission coil.

To improve the sensitivity, the polygon shaped sensing coil can be located closer to the foreign object than to the power transmission coil. In particular, it is possible that the detection system is placed such that the distance between the object and sensing coil is as small as possible or preferably less than 10 mm.

It is possible that the polygon shaped sensing coils are created using one continuous wire to create one complete turn of wire on each sector of the polygon.

It is possible that the polygon shaped sensing coil or a plurality of such coils are created using one continuous wire to create multiple complete turns of wire on each sector of the polygon.

It is possible that a detection coil is formed, arranged, or manufactured by combining regular polygons of equal number of sides or of different number of sides and sizes. For example, a hexagram can be formed by combining two equilateral triangles and one hexagon. In addition, the same hexagram can be formed by combining two rhombi or two parallelograms with two triangles. This is given just as way of example but is not limited to this construction method. Equally, the sensing coil can be preferably wound with a continuous wire without interconnecting middle points.

The wireless power transmission coil can be a single coil such as a non-polarized spiral coil, a multi-coil polarized transmitter, e.g. in a DD (“double D”) configuration, a bipolar coil and a polarized coil such as a solenoid coil.

It is possible that the transmission coil current is sensed using a wound current transformer. It is also possible that the current in the transmission coil is sensed using a Hall effect current transducer.

It is possible to determine the induced voltage or to compare the induced voltage to predicted voltage in normal operating conditions utilizing analog electric or electronic components. However, it is possible to use logic circuitry and to employ digital signals to create a corresponding output signal.

A comparison of voltage signals can compare the amplitude of two voltage signals directly.

It is possible to compare voltage signals based on their amplitude of corresponding rectified voltage signals.

It is possible that a comparison of the voltage signals can be performed by comparing the rate of change of the two voltage signals directly.

It is possible that voltage signals can be compared by comparing the rate of change of the two voltage signals after rectification.

It is possible to compare a voltage signal to a calibrated signal whose level indicates the absence of a foreign object or the presence of a vehicle which is not being charged when the wireless power transmission system is utilized to transfer electric power to a battery of an electric vehicle.

### BRIEF DESCRIPTION OF THE DRAWINGS

Basic working principles and details of preferred embodiments are shown in the accompanying schematic figures.

In the figures:

FIG. 1 shows a basic configuration of a foreign object detector;

FIG. 2 illustrates a foreign object detector having a resonance circuit;

FIG. 3 illustrates the use of a sensing coil having a triangular shape;

FIG. 4 illustrates a wireless power transfer system comprising two segments of a transmission coil and a plurality of sensing coils; and

FIGS. 5 to 19 show different possible shapes for sensing coils or sensing coils comprising several sensing coil elements.

### DETAILED DESCRIPTION OF ILLUSTRATIVE EMBODIMENTS

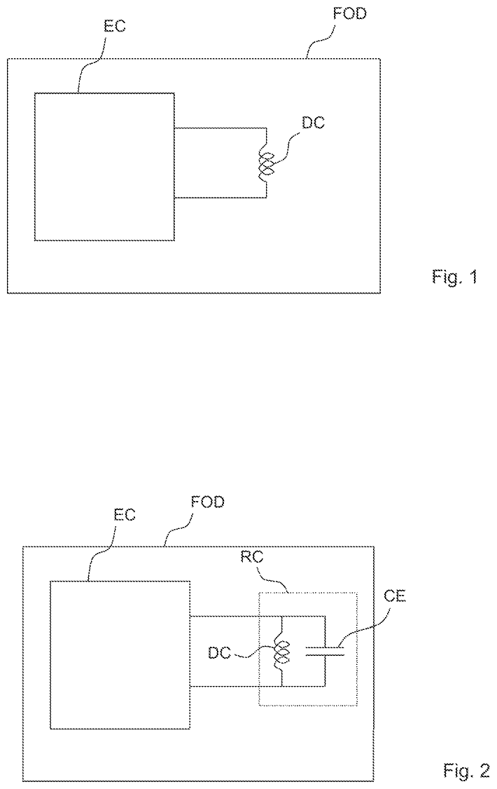

FIG. 1 shows an equivalent circuit diagram of a basic embodiment of a foreign object detector FOD. The foreign object detector FOD comprises an evaluation circuit EC and a sensing coil DC electrically connected to the evaluation circuit EC. The sensing coil DC can be arranged in the vicinity of wireless power transmission coil. When the wireless power transmission coil emits magnetic power then a voltage is induced in the sensing coil DC. The induced voltage has a linear dependence on the current in the transmission coil. When the evaluation circuit EC detects a deviation from an induced current, i.e. a deviation from an expected linear dependence, then the presence of a foreign object causing the deviation is highly likely and a corresponding output signal, e.g. a warning signal or a shutdown signal can be provided.

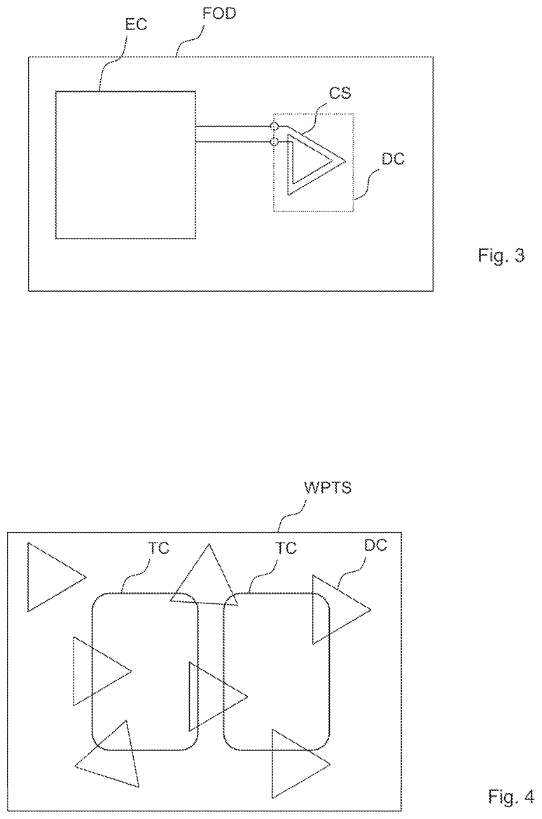

FIG. 2 illustrates the possibility of electrically connecting the sensing coil DC to a capacitance element CE. The sensing coil and the capacitance element can be electrically connected in series or in parallel. In both cases they establish a resonance circuit, the resonance frequency of which or the quality factor of which depends on the presence of a foreign object. Thus, monitoring the quality factor and/or the resonance frequency will provide the possibility to detect the presence of a foreign object, e.g. a metallic object.

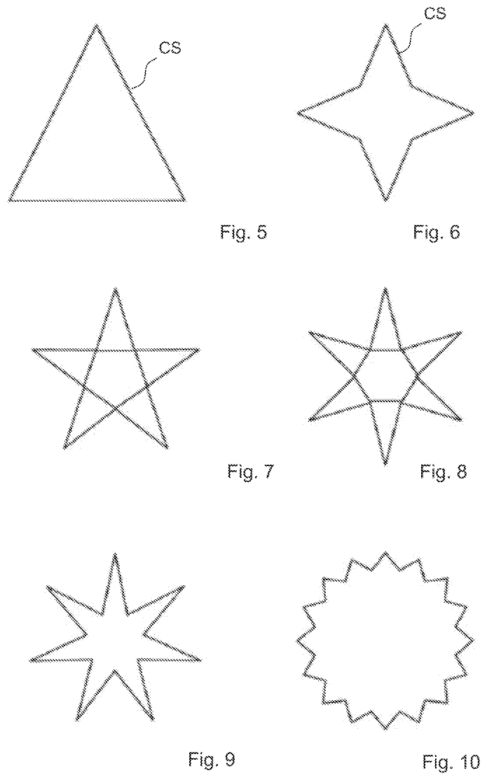

FIG. 3 shows the possibility of using a triangular shaped sensing coil DC. The triangular shaped sensing coil comprises a plurality of conductor segments CS electrically connected in series. Thus, a number of two or more windings can be obtained.

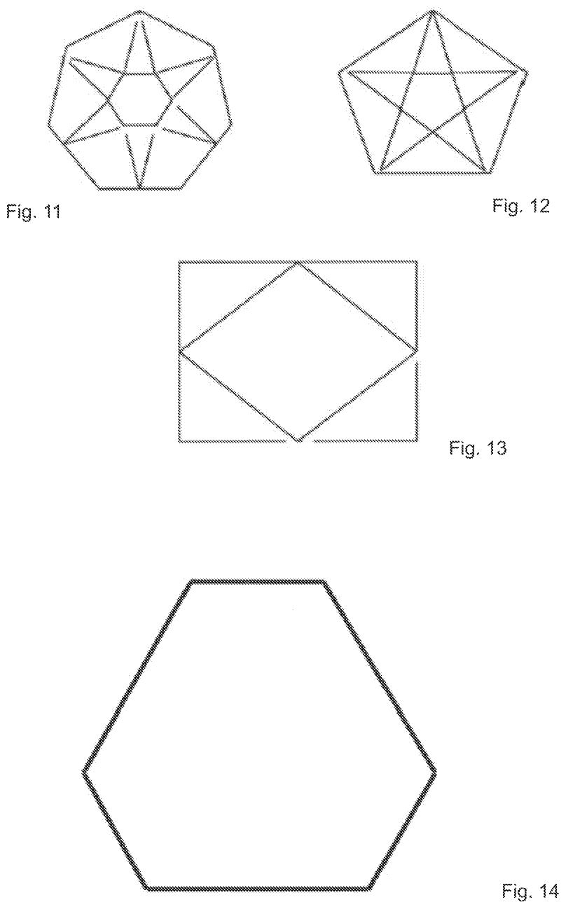

FIG. 4 shows a possible configuration of a wireless power transmission system WPTS together with sensing coils DC of a foreign object detector. The transmission coil TC of the wireless power transmission system WPTS has two conductor segments arranged in a DD coil configuration. A plurality of—in this example triangular—sensing coils DC are distributed over the extension of the system such that a good coverage of the detection area is obtained.

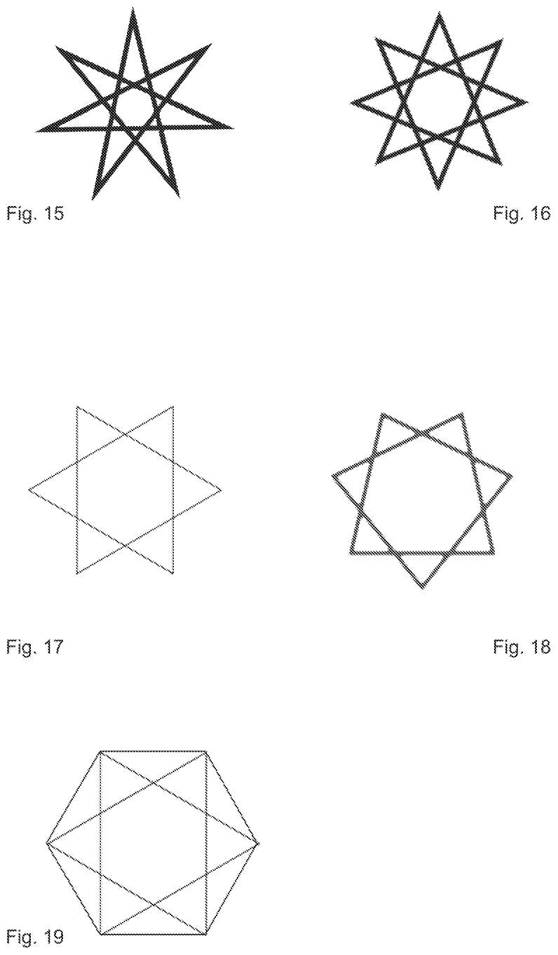

FIG. 5 shows the possibility of providing at least one sensing coil with a triangular shape as shown in FIG. 3. However, star shaped polygons, e.g. comprising eight conductor segments as shown in FIG. 6, or five conductor segments as shown in FIG. 7, are also possible.

FIG. 8 illustrates a possible shape where the sensing coil comprises several sensing coil elements. The sensing coil shape shown in FIG. 8 is composed of six triangles and one hexagon. One side of a triangle is located at a corresponding edge of the hexagon.

Further, FIG. 9 illustrates a star shaped polygon comprising fourteen conductor segments arranged in a symmetrical pattern.

Similarly, FIG. 10 shows a possible star shape comprising 32 straight conductor segments arranged in a symmetric star configuration.

FIG. 11 shows the possibility of combining a sensing coil as shown in FIG. 8 with a heptagon.

FIG. 12 illustrates the possibility of combining the sensing coil of FIG. 7 in a pentagon.

FIG. 13 illustrates the possibility of containing a first sensing coil element with four conductor segments in an outer sensing coil element consisting of a rectangle.

FIG. 14 illustrates the possibility of having a hexagon comprising two longer edges and two shorter edges.

FIG. 15 shows a sensing coil in the form of a heptagram.

FIG. 16 shows a sensing coil in the form of an octagram.

FIG. 17 shows a sensing coil in the form of a hexagram.

FIG. 18 shows another possible configuration of a heptagram coil with a bigger centre section compared to that of FIG. 15.

FIG. 19 shows another possible configuration of a polygram (hexagram in this example) with star points connected. The foreign object detector, the wireless power transmission system and the detection method are not limited to the technical details described or shown in the figures. The detector and the transmission system can comprise further circuit elements and the method can comprise further steps.

1-26. (canceled)

27. A foreign object detector comprising:
a plurality of sensing coils, each coil made of a plurality of straight strokes; and
an evaluation circuit connected to the sensing coils,
wherein the detector is configured to detect a metallic or magnetic object foreign to a top surface of a wireless power transmission device having a transmission coil.

28. The foreign object detector of claim 27, further comprising one or more additional polygon shaped sensing coils.

29. The foreign object detector of claim 28, wherein two or more sensing coils are electrically connected in series or in parallel.

30. The foreign object detector of claim 27, further comprising one or more additional evaluation circuits configured to determine a presence or an absence of a metallic or a magnetic material.

31. The foreign object detector of claim 27, wherein each sensing coil has a field direction perpendicular to a field direction of the transmission coil.

32. The foreign object detector of claim 27, wherein each sensing coil is a polarized coil.

33. The foreign object detector of claim 27, wherein each sensing coil has a core, and wherein the core is an air core, a ferromagnetic core, or a core with a relative permeability≤10000.

34. The foreign object detector of claim 27, wherein each sensing coil has a winding comprising a conductor, and wherein the conductor is an enameled wire, a litz wire, an insulated wire, or conduction segments structured on a wiring board.

35. The foreign object detector of claim 27, wherein each sensing coil is electrically connected with a capacitance element to establish a resonance circuit.

36. The foreign object detector of claim 27, wherein a conducting material of each sensing coil is copper, an alloy comprising copper, silver, or an alloy comprising silver.

37. The foreign object detector of claim 27, wherein one or more of the plurality of sensing coils are formed by at least 5 straight, crossing segments forming a pentagram shape.

38. The foreign object detector of claim 37, wherein the pentagram shaped sensing coil is enclosed by an outer coil that connects pentagram coil points.

39. The foreign object detector of claim 27, wherein one or more of the plurality of sensing coils is formed by at least 6 straight crossing segments forming a hexagram shape.

40. The foreign object detector of claim 39, wherein the hexagram shaped sensing coil is enclosed by an outer coil that connects hexagram coil points.

41. The foreign object detector of claim 39, wherein the hexagram shaped sensing coil is made by two series-connected equilateral triangular coils arranged to form the hexagram shape.

42. The foreign object detector of claim 39, wherein the hexagram-shaped sensing coil is made by two parallel-connected equilateral triangular coils arranged to form the hexagram shape.

43. The foreign object detector of claim 27, wherein one or more of the plurality of sensing coils is formed by at least 7 straight, crossing segments forming a heptagram shape.

44. The foreign object detector of claim 43, wherein the heptagram-shaped sensing coil is enclosed by an outer coil that connects heptagram points.

45. The foreign object detector of claim 27, wherein one or more of the plurality of sensing coils are formed by at least 8 straight, crossing segments forming an octagram shape.

46. The foreign object detector of claim 45, wherein the octagram-shaped sensing coil is enclosed by an outer coil connecting octagram points.

47. The foreign object detector of claim 27, wherein the sensing coils are formed by connecting in series or parallel regular polygons that are arranged so that a final shape is a polygram of n=5, 6, 7 or 8.

48. A wireless power transmission system comprising:
a transmission coil; and
the foreign object detector of claim 27.

49. A method for detecting a foreign object in a vicinity of a wireless power transmission system, the method comprising:
monitoring an induced voltage in the sensing coils;
determining a safety interval for an induced signal of a sensing coil;
monitoring the induced voltage in the sensing coils; and
triggering an activation signal when the induced voltage is outside a safety interval.

50. The method of claim 49, wherein the safety interval is determined according to a linear dependence between a current and the voltage induced in the sensing coil, or according to a change in a quality factor or a resonance frequency.

51. The method of claim 50, further comprising detecting a metal in a vicinity of a detector.
